(19) United States
(12) Patent Application Publication
(10) Pub. No.: US 2014/0293798 A1
(43) Pub. Date: Oct. 2, 2014

(54) MPLS-TP NETWORK AND LINK TRACE METHOD THEREOF

(71) Applicant: Electronics and Telecommunications Research Institute, Daejeon (KR)

(72) Inventors: Tae Kyu KANG, Daejeon (KR); YongWook RA, Daejeon (KR); Chang-ho CHOI, Daejeon (KR); Bup Joong KIM, Daejeon (KR)

(73) Assignee: Electronics and Telecommunications Research Institute, Daejeon (KR)

(21) Appl. No.: 14/080,237

(22) Filed: Nov. 14, 2013

(30) Foreign Application Priority Data
Mar. 27, 2013 (KR) 10-2013-0033053

(51) Int. Cl. H04L 12/26; H04L 12/723

(52) U.S. Cl. CPC H04L 43/10; H04L 45/50
USPC 370/241.1

(57) ABSTRACT

A MPLS-TP network includes a first router, at least one second router, and a third router. The first router is set to a MEP and generates and transmits a link trace packet. The second router is set to an MIP, generates a response packet in response to reception of the link trace packet, transmits the response packet in a direction of the first router, and forwards the link trace packet. The third router is set to the MEP, generates a response packet in response to reception of the forwarded link trace packet, and transmits the response packet in the first router direction.

### CROSS-REFERENCE TO RELATED APPLICATION

This application claims priority to and the benefit of Korean Patent Application No. 10-2013-0033053 filed in the Korean Intellectual Property Office on Mar. 27, 2013, the entire contents of which are incorporated herein by reference.

### BACKGROUND OF THE INVENTION

(a) Field of the Invention

The present invention relates to a multi-protocol label switching-transport profile (MPLS-TP) network and a link trace method in an MPLS-TP network. More particularly, the present invention relates to a method and apparatus for tracing a corresponding transmitting path and grasping a fault segment and a fault node, when a connectivity fault has occurred in an MPLS-TP network.

(b) Description of the Related Art

Multi-protocol label switching (MPLS) is standardized technology in IETF, and is 2.5 layer technology for improving inefficiency of Internet protocol (IP) packet switching and is technology that can provide a connection-oriented packet transport service by forming various service packets in a label.

An MPLS-TP is technology for performing standardization in ITU-T and IETF and is technology used for a packet transport network by advancing relatively weak MPLS operation, administration, and maintenance (OAM) and protection functions while using a function corresponding to a transport network in architecture and forwarding functions of existing MPLS. According to a definition of ITU-T, OAM of a network transport network apparatus should provide two functions of fault management and performance monitoring.

The fault management includes functions of continuity check and connectivity verification (CC-CV), loopback (LB), link tracing (LT), alarm indication signaling (AIS), remote defect indication (RDI), lock signaling (LCK), client signal failure (CSF), diagnostic testing (DT), and automatic protection switching (APS) for fault monitoring and restoration of a transport network.

The performance monitoring function includes a function of loss measurement (LM) and delay measurement (DM) for guaranteeing a QoS of a transport network.

ITU-T and IETF have had standardization discussions of such OAM functions for a long time, and were determined to provide an OAM solution with an individual method.

For a very efficient link trace function in grasping a fault position of OAM fault management, neither of the standardization institutions have had discussions related to a reason for a fast standardization process and complicated implementation.

In such a situation, an IETF MPLS trace route, which is the conventional art, has a problem that it does not satisfy contents “OAM should be able to operate without IP”, which is an MPLS-TP OAM requirement with a method basically using an IP protocol.

### SUMMARY OF THE INVENTION

The present invention has been made in an effort to provide a method and apparatus for tracing an MPLS-TP link having advantages of tracing a corresponding label switched path (LSP) and effectively grasping a position of a fault node without using IP, when a connectivity fault has occurred in an MPLS-TP network, by distinguishing an MEP/MIP using a logical MPLS-TP identifier Node_ID/Tunnel_NUM/LSP_NUM and a physical MPLS label and by defining and setting a database that maps a transmission segment of a packet LSP when setting an MEP/MIP for OAM to an MPLS-TP node constituting each MPLS-TP network.

An exemplary embodiment of the present invention provides a multi-protocol label switching-transport profile (MPLS-TP) network. The MPLS-TP network includes: a first router that is set to a maintenance entity group (MEG) end point (MEP) and that generates and transmits a link trace packet; at least one second router that is set to an MEG intermediate point (MIP) and that generates a response packet in response to reception of the link trace packet and that transmits the response packet in a direction of the first router and forwards the link trace packet; and a third router that is set to the MEP and that generates a response packet in response to reception of the forwarded link trace packet and transmits the response packet in the first router direction. The link trace packet and the response packet each include a first label representing a transmitting segment in which the link trace packet and the response packet each are transmitted and a message representing a link trace function, and the message includes packet kind information representing one of the link trace packet and the response packet, a label switched path (LSP) identifier representing an LSP between the first and third routers, a tunnel identifier representing a tunnel used, and a node identifier representing a router on the LSP.

Another embodiment of the present invention provides a link trace method. The link trace method of finding a transmitting segment in which a fault has occurred in an LSP between a first router and a second router of an MPLS-TP network includes: setting the first router to an MEP of the LSP and generating and transmitting, by the first router, a link trace packet; setting at least one third router on the LSP to an MIP of the LSP, generating, by the third router, a response packet in response to reception of the link trace packet, transmitting the response packet in a direction of the first router, and forwarding the received link trace packet in a direction of the second router; and setting the second router to an MEP of the LSP and generating, by the second router, a response packet in response to reception of the forwarded link trace packet and transmitting the response packet in a direction of the first router. The link trace packet and the response packet each include a first label representing a transmitting segment in which the link trace packet and the response packet each are transmitted and a message representing a link trace function, and the message includes packet kind information representing one of the link trace packet and the response packet, an LSP identifier representing the LSP, a tunnel identifier representing a using tunnel, and a node identifier representing a router on the LSP.

Yet another embodiment of the present invention provides a link trace method. The link trace method of a first router that is set to an MEP in an MPLS-TP network includes: generating and transmitting a link trace packet that sets a second router that is set to the MEP to a destination; receiving a response packet to the link trace packet from the second router; and receiving a response packet to the link trace packet from at least one third router that is set to an MIP on an LSP between the first router and the second router. The link trace packet and the response packet each include a first label representing a transmitting segment in which the link trace packet and the response packet are transmitted and a message representing a link trace function, and the message includes packet kind information representing one of the link trace packet and the response packet, an LSP identifier representing the LSP, a tunnel identifier representing a using tunnel, and a node identifier representing a router on the LSP.

### BRIEF DESCRIPTION OF THE DRAWINGS

FIG. 1 is a diagram illustrating an MPLS-TP OAM constituent element in an MPLS-TP network and a link tracing operation according to an exemplary embodiment of the present invention.

FIG. 2 is a diagram illustrating a form of a link trace message packet LTM and a link trace response packet LTR, which are link trace packets according to an exemplary embodiment of the present invention.

FIG. 3 is a diagram illustrating transmission flow of MPLS-TP link trace packets LTM and LTR according to an exemplary embodiment of the present invention.

FIG. 4 is a block diagram illustrating a configuration of an MPLS-TP node according to an exemplary embodiment of the present invention.

FIG. 5 is a flowchart illustrating a receiving and processing process of OAM packets LTM and LTR in an MEP/MIP according to an exemplary embodiment of the present invention.

FIG. 6 is a flowchart illustrating a transmitting processing process of a link trace message packet LTM in an MEP according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

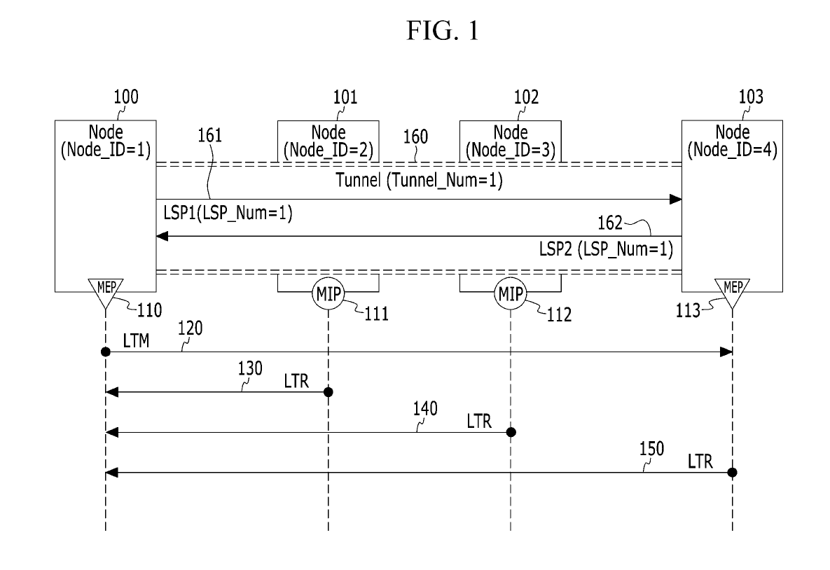

FIG. 1 is a diagram illustrating an MPLS-TP OAM constituent element in an MPLS-TP network and a link tracing operation according to an exemplary embodiment of the present invention. First, in order to easily describe the present invention, terms and concepts that are related to the present invention are defined.

In an IETF RFC 6371 document, a framework for supporting an OAM processing procedure of MPLS-TP nodes 100-103 in an MPLS-TP network is defined. In this case, MPLS-TP nodes 100-103 are MPLS-TP apparatuses. An MPLS-TP apparatus is a label edge router (LER) or a label switched router (LSR).

A maintenance entity (ME) represents a relationship between two random points of a transport path for management, such as maintenance and monitoring in an MPLS-TP network, and an MPLS-TP ME is a section, a label switched path (LSP), and a pseudo-wire (PW).

An ME group (MEG) indicates at set of least one ME that belongs to the same transport path and that maintains and monitors as a group.

An MEG endpoint (MEP) is an end management point of an LSP and indicates both end points that define an ME. The MEP generates, transmits, and ending-processes all OAM packets, and in only some cases, the MEP generates and transmits a response packet. An MEP that generates an OAM packet based on a uni-direction is a source MEP and is referred to as a destination of the OAM packet, and an MEP that terminates the OAM packet is referred to as a target MEP or a sink MEP.

An MEG intermediate point (MIP) is an intermediate management point of the LSP and is a midpoint between two MEP points. The MIP may generate and transmit only a response packet of the OAM packet that it receives from a source MEP.

In an IETF RFC 6370 document, in the MPLS-TP network, an MPLS-TP identifier for setting and managing an element and an object of an MPLS-TP environment through a control management plane of an MPLS-TP node is defined.

First, a node identifier Node_ID, which is one of MPLS-TP identifiers, is an identifier used for identifying an MPLS-TP node. The node identifier Node_ID has a unique value within an MPLS-TP network. The MPLS tunnel identifier Tunnel_Num, which is one of the MPLS-TP identifiers, is an identifier indicating a tunnel 160 for a service that is provided by a working LSP and a protection LSP between the MPLS-TP nodes. The MPLS tunnel identifier Tunnel_Num has a unique value within the node identifier Node_ID. The LSP identifier LSP_Num is an identifier indicating uni-direction LSPs 161 and 162 constituting the tunnel 160. The LSP identifier LSP_Num has a unique value within the MPLS tunnel identifier Tunnel_Num. In a co-routed bidirectional LSP constituting a transport path through the same equipment, the same LSP identifier LSP_Num value is used for two uni-direction LSPs 161 and 162. However, in an associated bidirectional LSP constituting a transport path through different equipment, different LSP identifier LSP_Num values are used for two uni-direction LSPs. FIG. 1 illustrates a co-routed bi-directional LSP constituting a transport path through the same equipment. The LSP identifier LSP_Num is mapped to an MPLS label value used for data plane forwarding of the MPLS-TP nodes 100-103, and is mapped to two MPLS labels for the bi-directional LSPs. Therefore, when an MEP/MIP identifier (specifically, a node identifier Node_ID, an MPLS tunnel identifier Tunnel_Num, and an LSP identifier LSP_Num) and a database to which an LSP label is mapped are set to each of the nodes 100-103 of the MPLS-TP, the MEP/MIP identifier and the database may be used together for data forwarding and OAM processing.

Referring to the above-described terms and concepts, a basic operation of link tracing for point-to-point bi-directional LSPs that are set for the service tunnel 160 between MPLS-TP nodes 100-103 that are illustrated in FIG. 1 is described as follows. For convenience of description, the MPLS-TP network is formed with MPLS-TP nodes 100-103, MEPs 110 and 113, and MIPs 111 and 112, that are related to an LSP transport path are set to the nodes 100-103, respectively, and it is assumed that a continuity fault is detected through a continuity check message (CCM) of OAM.

When the first MEP 110 traces LSP transport paths between the first MEP 110 and the second MEP 113 to a source MEP through a superordinate on-demand command, the first MEP 110 generates a link trace message (LTM) packet 120 that sets a target MEP ID to {4, 1, 1} and transmits the LTM 120 in a direction of the first MIP 101. Here, {4, 1, 1} are values of {Node_ID, Tunnel_Num, LSP_Num}, respectively, and are identifiers of the second MEP 113.

The first MIP 111 forwards the LTM packet 120 having been received from the first MEP 110 to the second MIP 112, and generates and transmits a link trace reply (LTR) packet 130 that sets a reply ID to {2, 1, 1} in a direction (i.e., to the first MEP 110) opposite to a receiving direction of the LTM packet 120. Here, {2, 1, 1} are values of {Node_ID, Tunnel_Num, LSP_Num}, respectively and are an identifier of the first MIP 111.

The second MIP 112 forwards the LTM packet 120 having been received from the first MIP 111 to the second MEP 113, and generates and transmits an LTR packet 130 that sets a reply ID to {3, 1, 1} in a direction (i.e., to the first MIP 111) opposite to a receiving direction of the LTM packet 120. Here, {3, 1, 1} are values of {Node_ID, Tunnel_Num, LSP_Num}, respectively, and are identifiers of the second MIP 112.

The second MEP 113 is a target MEP and performs an end processing of the LTM packet 120 having been received from the second MIP 112, and generates and transmits an LTR packet 150 that sets a reply ID to {4, 1, 1} in a direction (i.e., to the MIP2 112) opposite to a receiving direction of the LTM packet 120. Here, {4, 1, 1} are values of {Node_ID, Tunnel_Num, LSP_Num}, respectively, and are identifiers of the second MEP 113.

Forwarding of the LTM packet 120 and LTR packets 130, 140, and 150 in the first MIP 111 and the second MIP 112 is performed through the same fate-sharing as data packet forwarding.

The first MEP 110 performs end processing of LTR packets 130, 140, and 150 from the first MIP 111, the second MIP 112, and the second MEP 113, respectively, checks a reply ID of the LTR packets 130, 140, and 150, and grasps a position (transmission segment) in which a failure has occurred. For example, when a connectivity fault occurs in an LSP transmission path between the second MIP 112 and the second MEP 113 of the LSP transport paths between the first MEP 110 and the second MEP 113, the first MEP 110 receives the LTR packets 130 and 140 in which a reply ID is the first MIP 111 and the second MIP 112, but does not receive the LTR packet 150 in which a reply ID is the second MEP 113, and thus it can be grasped that a position at which a fault has occurred is a segment of the second MIP 112—the second MEP 113.

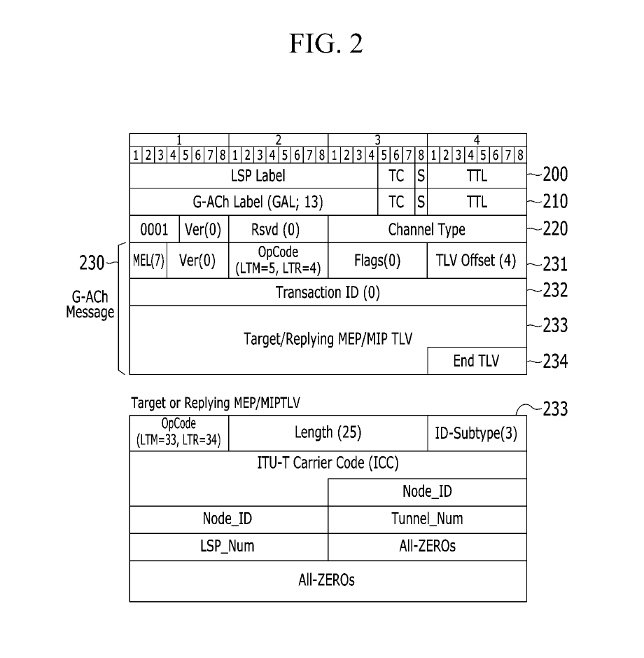

FIG. 2 is a diagram illustrating a form of an LTM packet and an LTR packet, which are packets for link trace according to an exemplary embodiment of the present invention.

The LTM and LTR packets, which are OAM packets according to an exemplary embodiment of the present invention, have a common packet form of a general MPLS label 200, a G-ACh label (GAL) 210, a generic-associated channel header (G-ACh header) 220, and a G-ACh message 230. Each OAM function has different G-ACh message values.

The general MPLS label 200 is formed with an LSP label representing an MPLS-TP transport path, a traffic class (TC) representing a QoS parameter, S (bottom of stack; 1 at the bottom) representing a label position, and time to live (TTL) representing the node hop number to a destination. At least one MPLS label 200 exists and forms a stack.

The GAL 210 is an MPLS label for MPLS-TP OAM, is positioned after an MPLS label to manage, and is formed with a fixed LSP label=13, TC, S (=1), and TTL. When a destination of the OAM packet is an MEP, if an MPLS label (e.g., 200) before the GAL is popped, the GAL 210 is exposed and OAM processing is performed, and when a destination of the OAM packet is an MIP, if a TTL value of the MPLS label has expired (i.e., TTL=1; TTL is reduced by 1 whenever passing through an MPLS-TP node) before the GAL, the GAL 210 is exposed. However, in link trace LT, even if TTL=1 is not true, when the LTM packet is received, the MIP should perform response processing. When a destination of the OAM packet is an MEP, the TTL is set to 255, and when a destination of the OAM packet is an MIP, a hop count value to the MIP is set to the TTL.

The G-ACh header 220 is formed with a divider (=0b0001), version (=0), and reserved (=0) notifying ACh, and a channel type representing an OAM function IETF or an OAM method ITU-T. Here, when a channel type field value represents IETF, the G-ACh header 220 represents an OAM function (e.g., LB, CC), and when a channel type field value represents ITU-T, the G-ACh header 220 represents an OAM method (e.g., ITU-T method 0x8902). Hereinafter, for convenience of description, when an OAM of an ITU-T method is used, it is assumed that a value of a channel type is set to 0x8902. In the present invention, a G-ACh Message 230 for link trace LT is defined with reference to target MEP/MID TLV that is defined in ITU-T G.8113.1 advice and an MPLS-TP identifier that is defined in an IETF RFC 6370 document.

The G-ACh message 230 for link trace LT is formed with an OAM protocol data unit (PDU) common header 231, a transaction ID 232, a target/replying MEP/MIP TLV 233, and an end TLV 234.

The common header 231 is formed with MEL (=7), version (=0), and OpCode (LTM=5, LTR=4) representing a management domain level, flag (=0) representing a state, and TLV Offset (=4) representing the byte number to a next TLV.

The transaction ID 232 is a field for determining an LTM-LTR interrelation, but is not used (set to 0).

The target/replying MEP/MIP TLV 233 is a type, length, and value (TLV) for defining identification of a destination of LTM and identification of a response location of LTR, and is formed as a type for distinguishing whether a target MEP/MIP TLV (Type=33; use LTM) or a replying MEP/MIP TLV (Type=34; use LTR), a length (=25) representing a TLV length, an ID-subtype (=3; use ICC based MIP ID) representing a type of an identifier, a Node_ID which is an MPLS-TP node identifier, Tunnel_Num which is an MPLS tunnel identifier between apparatuses, and LSP_Num which is an LSP identifier within a tunnel.

The end TLV 234 is a TLV notifying a final packet.

When the OAM packet is transmitted to a network through an ethernet, an ethernet header (MAC Address, VLAN, FCS) is added to the packet form.

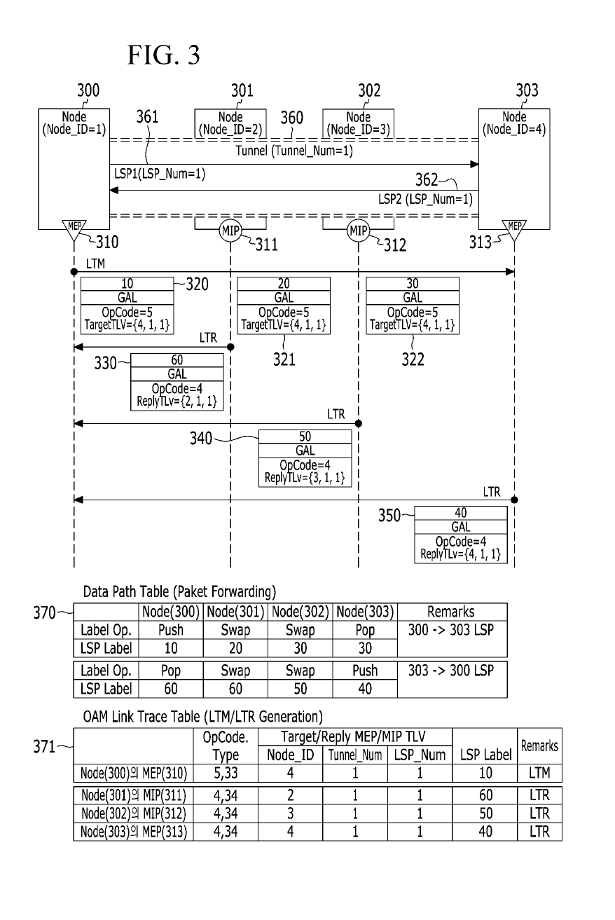

FIG. 3 is a diagram illustrating transmission flow of MPLS-TP link trace packets LTM and LTR according to an exemplary embodiment of the present invention.

According to an exemplary embodiment of the present invention, for a service tunnel 360 between MPLS-TP nodes 300, 301, 302, and 303, when setting MEPs 310 and 313 and MIPs 311 and 312 for point to point bi-directional LSP transport paths 361 and 362, for generation & transmission/forwarding/end of LTM and LTR packets between MEP-MEP/MIP, related databases 370 and 371 should be set to each node, and contents thereof are as follows. A description will be made with reference to a form of a packet LTM and a packet LTR for link trace that is shown in FIG. 2.

For transmission of an LTM packet, when the first MEP 310 is set to a source MEP and the second MEP 313 is set to a target MEP, each MEP/MIP identifier on the LSP 361 to the first MEP 310->the second MEP 313 and a label value of each transmitting segment of the LSP1 361 are defined by Table 1.

TABLE 1
First MIP ID = {Node_ID = 2, Tunnel_Num = 1, LSP_Num = 1}
Second MIP ID = {Node_ID = 3, Tunnel_Num = 1, LSP_Num = 1}
Second MEP ID = {Node_ID = 4, Tunnel_Num = 1, LSP_Num = 1}
First MEP - first MIP segment of LSP1 uses LSP Label 10
First MIP - second MIP segment of LSP1 uses LSP Label 20
Second MEP - second MEP segment of LSP1 uses LSP Label 30

In contrast, for an LTR, each MEP/MIP identifier on the LSP transport path 362 to the second MEP 313->the first MEP 310 is the same as an MEP/MIP identifier for the LTM, and a label value of each transmitting segment of the LSP2 362 is defined by Table 2.

TABLE 2
The first MIP ID, the second MIP ID, and the second MEP ID are the
same as described above
The second MEP-the second MIP segment of LSP2 uses LSP Label 40
The second MIP-the first MIP segment of LSP2 uses LSP Label 50
The first MIP-the first MEP segment of LSP2 uses LSP Label 60

When rearranging the foregoing description, a data path table 370 for forwarding data or an OAM packet and an OAM link trace table 371 for generation and response of an LTM/LTR packet should be set to each of the nodes 300-303. For example, when setting the first MEP 310 to the first node 300, for data transmitting processing, {LSP Label=10, Label Op.=Push} is set to the data path table 370, and for data receiving processing, {LSP Label=60, Label Op.=POP} is set to the data path table 370. Further, in the OAM link trace table 371, in order to generate an LTM that sets the second MEP 313 as a destination, variable fields of a link trace packet form that is described in FIG. 2 are set to LSP Label=10, TTL=255, OpCode=5 (LTM), Type=33 (LTM), and Node_ID, Tunnel_Num, and LSP_Num of Target MEP TLV={4, 1, 1}.

It is assumed that the MPLS-TP network is formed with the MPLS-TP nodes 300, 301, 302, and 303, and in each node, the databases 370 and 371 are set to MEP/MIPs 310, 311, 312, and 313 that are related to an LSP.

When the first MEP 310 traces LSPs 361 and 362 between the first MEP 310—the second MEP 313 through a superordinate on-demand command, the first MEP 310 generates an LTM packet 320 that is set to LSP Label=10, OpCode=5 (LTM), Type=33 (Target MEP/MIP TLV), and Target MEP ID={4, 1, 1} of the MPLS label, and transmits the LTM packet 320 in a direction of the first MIP 311. Because the first MIP 311 is not a destination of the LTM packet 320 having been received from the first MEP 310, the first MIP 311 swaps to LSP Label=20 through a data packet forwarding process, forwards the LTM packet 320 to the second MIP 312, generates an LTR packet 330 that is set to LSP Label=60, OpCode=4 (LTR), Type=34 (Replying MEP/MIP TLV), and Reply ID={2, 1, 1} of the MPLS label, and transmits the LTR packet 330 in a direction opposite to a receiving direction of the LTM packet 320.

Because the second MIP 312 is not a destination of an LTM packet 321 having been received from the first MIP 311, the second MIP 312 swaps to LSP Label=30 through a packet forwarding process, forwards the LTM packet 321 to the second MEP 313, generates the LTR packet 330 that is set to LSP Label=50, OpCode=4, Type=34, and ReplyID={3, 1, 1} of the MPLS label, and transmits the LTR packet 330 in a direction opposite to a receiving direction of the LTM packet 321.

An MPLS label, which is LSP Label=30, is popped to a destination of an LTM packet 322 having been received from the second MIP 312, and thus the GAL 210 is exposed, and the second MEP 313 generates an LTR packet 350 that is set to LSP Label=40, OpCode=4, Type=34, and Reply ID={4, 1, 1} of the MPLS label and transmits the LTR packet 350 in a direction opposite to a receiving direction of the LTM packet 322.

LTR packets 340 and 350 having been received in the first MIP 311 and the second MIP 312 are transported to the first MEP 310, which is a destination, while swapping the MPLS label through the same packet forwarding process as LTM packet forwarding to the first MEP 310->the second MEP 313. The MPLS label of the LTR packets 330, 340, and 350 having been transported to the first MEP 310 is finally popped, and the GAL 210 of the LTR packets 330, 340, and 350 is exposed and OAM processing is performed. For example, the LTR packet 350 having an MPLS label of LSP Label=40 that is pushed in the second MEP 313 is swapped to an MPLS label of LSP Label=50 in the second MIP 312, and is swapped to an MPLS label of LSP Label=60 in the first MIP 311, and in the first MEP 310, the MPLS label is popped.

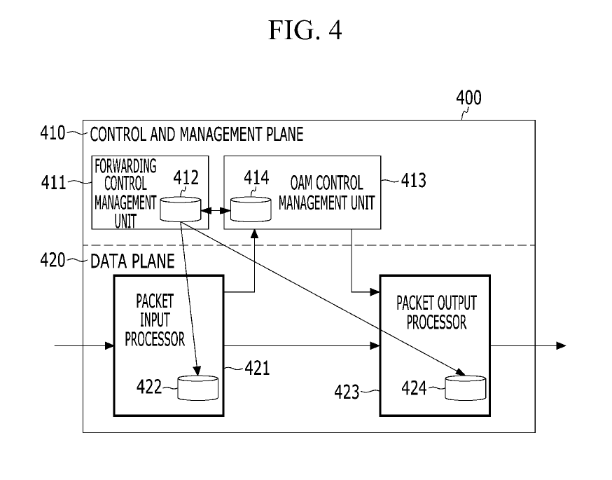

FIG. 4 is a block diagram illustrating a configuration of an MPLS-TP node according to an exemplary embodiment of the present invention.

An MPLS-TP node 400 according to an exemplary embodiment of the present invention includes a control and management plane 410 and a data plane 420. The MPLS-TM node 400 that is shown in FIG. 4 is formed with the same configuration as the MPLS-TP nodes 100-103 and 300-303 that are respectively shown in FIGS. 1 and 3.

The control and management plane 410 processes control information about connection, setting, maintenance, and cancellation of a node resource (physical interface, LSP, tunnel, etc.) and performs general operations of maintenance of a node, traffic state management, layer management (operation state), and plane management (system management).

A forwarding control management unit 411 performs a function of managing a database 412 that is related to identifier information used for setting and management of a resource in the control management plane 410 and databases 422 and 424 that are related to information (L2 Header, MPLS Label) that is used for packet forwarding in the data plane 420.

An OAM control management unit 413 generates an OAM packet and transports the OAM packet to a packet output processor 423 of the data plane 420, the OAM control management unit 413 reports an OAM event of the OAM packet having been received through a packet input processor 421 of the data plane 420 to a related control management unit or generates a response packet of the received packet, and transports the response packet to the packet output processor 423 of the data plane 420. In this case, the MPLS label, which is forwarding information of a used OAM database 414, is received from the database 412 of the forwarding control management unit 411.

The data plane 420 performs entire packet processing of generation & PUSH, forwarding PUSH/SWAP, and POP of the MPLS-TP data packet based on the databases 412 and 414 that are set in the control management plane 410. Further, the data plane 420 performs a function of fate-sharing an OAM packet through the same process as a process of the data packet, and a function of transmitting and receiving the OAM packet to and from the control management plane 410.

The packet input processor 421 performs end processing with reference to a forwarding database 422 of the received MPLS-TP packet, or updates MPLS label information for forwarding and transports the MPLS label information to the packet output processor 423. Further, when OAM packet processing is necessary (e.g., when an MPLS label (e.g., 200 of FIG. 2) is popped before GAL or when TTL of an MPLS label is 1 before GAL), the packet input processor 421 transports the OAM packet to the OAM control management unit 413 of the control management plane 410.

The packet output processor 423 updates L2 header information of an MPLS-TP packet having been received from the packet input processor 421 or the OAM control management unit 413 of the control management plane 410 with reference to the output database 424, and transmits the packet to a corresponding port.

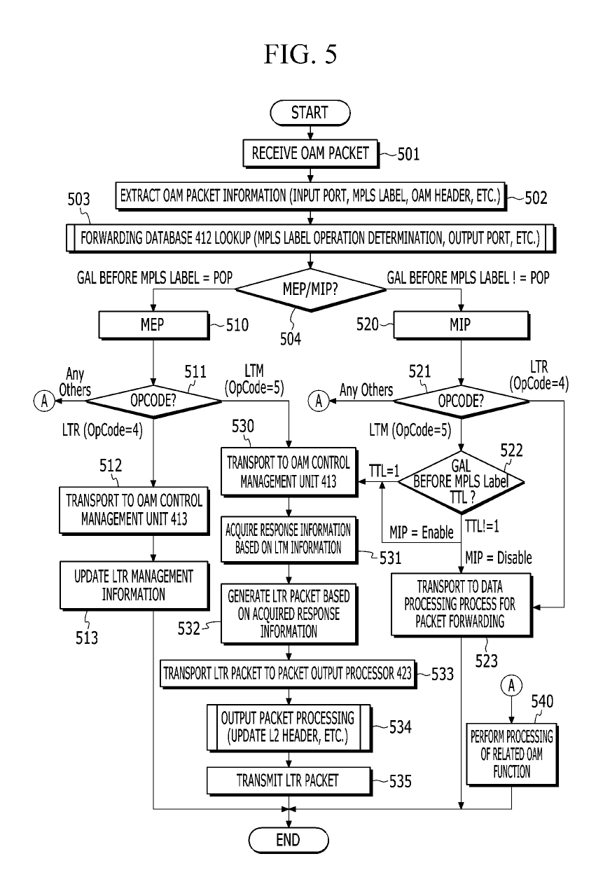

FIG. 5 is a flowchart illustrating a receiving processing process of LTM and LTR packets for link trace in an MEP/MIP according to an exemplary embodiment of the present invention.

When each node of MPLS-TP in which an MEP/MIP is set receives a link trace packet LTM/LTR, each node performs a series of operations of end processing of a packet, responding to a packet, or forwarding a packet through a process of FIG. 5.

When the packet input processor 421 of the MPLS-TP node (e.g., 300-303 of FIG. 3) receives an MPLS-TP packet, the packet input processor 421 first checks an MPLS label stack and classifies an OAM packet having the GAL 210 (501).

In order to determine operation of the received OAM packet, the packet input processor 421 extracts an input port, MPLS label(s), and an OAM common header (502).

The packet input processor 421 searched for the forwarding database 412 using MPLS label information that it extracts from the received packet, and acquires information of an output port and operation (PUSH/POP/SWAP) of MPLS label(s) (503).

The packet input processor 421 determines whether a present node of a received OAM packet is an MEP/MIP according to an MPLS label operation result (504), and if operation of an MPLS label before GAL is POP, the present node is an MEP, and if operation of an MPLS label before GAL is not POP, the present node is an MIP.

When the present node is an MEP (510), the packet input processor 421 determines an OpCode of the extracted OAM common header (511). If the OpCode is LTM (=5), the MEP is a target MEP (e.g., 313 of FIG. 3), and thus the following process for an LTM response is performed based on extracted information from the received packet (530-535). If an OpCode is LTR(=4), the MEP is a source MEP (e.g., 310 of FIG. 3), having transmitted the LTR, and thus the packet input processor 421 transports the OAM packet to the OAM control management unit 413 (512) and updates LTR management information of the LTM (513). In other OpCodes, processing of a related OAM function is performed (540) and the process is terminated.

When the present node is an MIP (520), the packet input processor 421 determines an OpCode of the extracted OAM common header (521). If an OpCode is an LTM (=5), the packet input processor 421 determines TTL of the MPLS label before GAL (522). When the TTL of the MPLS label is 1 before GAL, the MIP is a target MIP, and thus end processing of the packet is performed and the following process for an LTM response is performed based on information that is extracted from the received packet (530-535). If TTL of the MPLS label 1 is not before GAL, only when the MIP is in an enable state is a process for an LTM response performed based on information that is extracted from the received packet (530-535), and the received packet is forwarded. When the MIP is not enabled, only forwarding of the received packet is performed. When the OpCode is LTR (=4), the OAM packet is transported to a data processing process for packet forwarding to the target MEP (523), and the process is terminated. In other OpCodes, processing of a related OAM function is performed (540), and the process is terminated.

In the MEP/MIP, if the OpCode is the LTM (=5), the OAM packet is transported to the OAM control management unit 413 (530). The OAM control management unit 413 searches for the OAM database 414 based on information (input port, MPLS label, target MEP/MIP TLV) of the received LTM packet, acquires information for generating a response packet (e.g., MPLS label before GAL, node identifier Node_ID, MPLS tunnel identifier Tunnel_Num, and LSP identifier LSP_Num) (531), generates an LTR packet based on the information (532), and transports the LTR packet to the packet output processor 423 (533). The packet output processor 423 updates L2 header information with reference to the output database 424 (534), and transmits the LTR to a corresponding port (535) and the process is terminated.

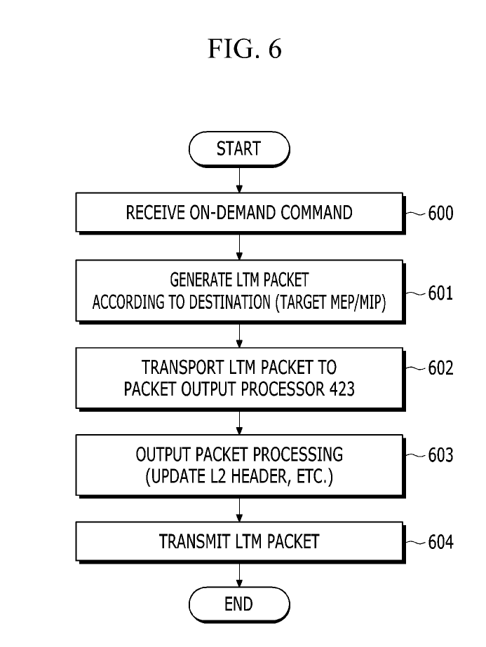

FIG. 6 is a flowchart illustrating a transmitting processing process of a link trace message packet LTM in an MEP according to an exemplary embodiment of the present invention.

The LTM packet may be generated in only an MPLS-TP node (e.g., 300 of FIG. 3) that is set to the MEP, and the LTM packet is generated and transmitted through the following steps.

The OAM control management unit 413 performs a generation process of an LTM packet according to a superordinate on-demand command (600).

The OAM control management unit 413 acquires an MPLS label, node identifier Node_ID, MPLS tunnel identifier Tunnel_Num, and LSP identifier LSP_Num information for generation of an LTM packet from the OAM database 414 based on information that it receives through the command, generates an LTM packet (601), and transports the LTM packet to the packet output processor 423 (602). When a destination is an MEP, the TTL of the MPLS label is set to 255, and when a destination is MIP, the hop count to the MIP is set to a TTL value.

The packet output processor 423 updates L2 header information with reference to the output database 424 (603) and transmits an LTM packet to a corresponding port (604), and the process is terminated.

According to the present invention, by embodying a link trace function in an existing MPLS-TP apparatus without using an IP by combining and using an MPLS-TP identifier (defined in an IETF RFC 6370 document) that is defined in standardization and a target or response MEP/MIP TLV (defined in ITU-T G.8113.1) form, when a connectivity fault occurs in an MPLS-TP network, in order to trace a corresponding path and to grasp a position of a fault segment (or a fault node), a fault can be easily managed, compared with an existing method of using IP or performing loopback several times.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A multi-protocol label switching-transport profile (MPLS-TP) network, comprising:
a first router that is set to a maintenance entity group (MEG) end point (MEP) and that generates and transmits a link trace packet;
at least one second router that is set to an MEG intermediate point (MIP) and that generates a response packet in response to reception of the link trace packet and that transmits the response packet in a direction of the first router and forwards the link trace packet; and
a third router that is set to the MEP and that generates a response packet in response to reception of the forwarded link trace packet and transmits the response packet in the first router direction,
wherein the link trace packet and the response packet each comprise a first label representing a transmitting segment in which the link trace packet and the response packet each are transmitted and a message representing a link trace function, and
the message comprises packet kind information representing one of the link trace packet and the response packet, a label switched path (LSP) identifier representing an LSP between the first and third routers, a tunnel identifier representing a tunnel used, and a node identifier representing a router on the LSP.

2. The MPLS-TP network of claim 1, wherein the node identifier of the link trace packet represents the third router, which is a destination node,
the node identifier of the response packet represents a router that generates the response packet,
the third router performs end processing of the received link trace packet when the third router receives the link trace packet if a node identifier of the link trace packet represents the third router, and
the first router finds a transmitting segment in which a fault has occurred in an LSP between the first router and the third router using information of the received response packet.

3. The MPLS-TP network of claim 2, wherein the transmitting segment represents a segment between a router and a next router on the LSP, and the LSP comprises a first LSP which is in a direction of the third router in the first router, and a second LSP which is in a direction of the first router in the third router,
the first label is an MPLS label and comprises an LSP label representing the transmitting segment and a time to live (TTL) field representing the node hop number to a destination,
there is at least one first label included in each of the link trace packet and the response packet, and
the link trace packet and the response packet each further comprise a generic-associated channel (G-Ach) label, which is positioned after the first label to manage, for operation, administration, and maintenance (OAM).

4. The MPLS-TP network of claim 3, wherein the LSP identifier of the link trace packet represents the first LSP and the LSP identifier of the response packet represents the second LSP,
forwarding of the link trace packet is performed with the same method as forwarding of a data packet on the first LSP, and
forwarding of the response packet is performed with the same method as forwarding of a data packet on the second LSP.

5. The MPLS-TP network of claim 3, wherein the LSP identifier of the link trace packet represents the first LSP and the LSP identifier of the response packet represents the second LSP,
the first router generates and transmits the link trace packet comprising an LSP label representing a transmitting segment between the first router and a next router after the first router on the first LSP and a node identifier representing the third router,
the second router that receives the link trace packet replaces an LSP label of the received link trace packet with an LSP label representing a transmitting segment between the second router and a next router after the second router on the first LSP and forwards the packet to a next router after the second router on the first LSP, and
the third router having received the link trace packet removes a first label comprising an LSP label from the link trace packet and performs end processing of the link trace packet when the node identifier of the link trace packet represents the third router.

6. The MPLS-TP network of claim 5, wherein the second router having received the link trace packet generates a response packet comprising an LSP label representing a transmitting segment between the second router and a next router after the second router on the second LSP and a node identifier representing the second router and transmits the response packet to a next router after the second router on the second LSP, and
the third router having received the link trace packet generates a response packet comprising an LSP label representing a transmitting segment between the third router and a next router after the third router on the second LSP and a node identifier representing the third router and transmits the response packet to a next router after the third router on the second LSP.

7. The MPLS-TP network of claim 6, wherein the second router that receives the response packet replaces an LSP label of the received response packet with an LSP label representing a transmitting segment between the second router and a next router after the second router on the second LSP and forwards the packet to a next router after the second router on the second LSP, and
the first router having received the response packet finds a transmitting segment in which a fault has occurred in the LSP using a node identifier of the response packet.

8. The MPLS-TP network of claim 7, wherein a G-ACh label of the response packet is exposed when a first label before the G-ACh label is removed, and when the G-ACh label of the response packet is exposed, a response node list for determining a fault transmitting segment is updated using a message of the response packet.

9. The MPLS-TP network of claim 7, wherein the first router, the second router, and the third router each on the LSP comprise a data path table for forwarding of a data packet or an OAM packet and a link trace table for generation of the link trace packet or the response packet,
a data path table of each router on the LSP comprises label operation information representing one of generation, replacement, and removal operations of the first label and the LSP label for packet transmission/reception, and
a link trace table of each router on the LSP comprises the packet kind information, the node identifier, the tunnel identifier, the LSP identifier, and the LSP label.

10. The MPLS-TP network of claim 9, wherein the first router and the third router each set a data path table and a link trace table thereof when the first router and the third router each are set to an MEP of the LSP, and the second router sets a data path table and a link trace table thereof when the second router is set to an MIP of the LSP, and
the first router sets a node identifier of a link trace table thereof to represent the third router, which is a destination, and the second router sets a node identifier of a link trace table thereof to represent the second router, and the third router sets a node identifier of a link trace table thereof to represent the third router.

11. The MPLS-TP network of claim 10, wherein the first router, the second router, and the third router each comprise a control management plane and a data plane,
the control management plane comprises a forwarding control management unit and an OAM control management unit and sets and manages a node resource, and
the data plane comprises a packet input processor and a packet output processor and generates, forwards, or end processes the packet.

12. The MPLS-TP network of claim 11, wherein the forwarding control management unit comprises an identifier database that is related to identifier information that is used for setting and management of the node resource and manages a forwarding database and an output database that are related to information that is used for forwarding of a packet in the data plane,
the OAM control management unit generates an OAM packet, transports the OAM packet to the packet output processor, and processes an event of the OAM packet that is received through the packet input processor,
the packet input processor comprises the forwarding database and performs end processing of an input packet with reference to the forwarding database or updates the first label information for forwarding and transports the first label information to the packet output processor, and when a first label before a G-ACh label of the input OAM packet is removed, the packet input processor transports the OAM packet to the OAM control management, and
the packet output processor comprises the output database and receives a packet from the packet input processor or the OAM control management unit, updates data link layer header information of the received packet with reference to the output database and transmits the updated packet.

13. A link trace method of finding a transmitting segment in which a fault has occurred in an LSP between a first router and a second router of an MPLS-TP network, the link trace method comprising:
setting the first router to an MEP of the LSP and generating and transmitting, by the first router, a link trace packet;
setting at least one third router on the LSP to an MIP of the LSP, generating, by the third router, a response packet in response to reception of the link trace packet, transmitting the response packet in a direction of the first router, and forwarding the received link trace packet in a direction of the second router; and
setting the second router to an MEP of the LSP, generating, by the second router, a response packet in response to reception of the forwarded link trace packet and transmitting the response packet in a direction of the first router,
wherein the link trace packet and the response packet each comprise a first label representing a transmitting segment in which the link trace packet and the response packet each are transmitted and a message representing a link trace function, and
the message comprises packet kind information representing one of the link trace packet and the response packet, an LSP identifier representing the LSP, a tunnel identifier representing a tunnel used, and a node identifier representing a router on the LSP.

14. The link trace method of claim 13, further comprising:
performing, by the second router having received the link trace packet, end processing of the received link trace packet, when a node identifier of the link trace packet represents the second router; and
finding, by the first router having received the response packet, a fault transmitting segment using a node identifier of the received response packet,
wherein the node identifier of the link trace packet represents a destination router, and the node identifier of the response packet represents a router that generates the response packet.

15. The link trace method of claim 14, wherein the transmitting segment represents a segment between a router on the LSP and a next router, and the LSP comprises a first LSP, which is in a direction of the second router in the first router and a second LSP, which is in a direction of the first router in the second router,
the first label is an MPLS label and comprises an LSP label representing the transmitting segment and a time to live (TTL) field representing a node hop number to a destination,
there is at least one first label included in each of the link trace packet and the response packet, and
the link trace packet and the response packet each further comprise a generic-associated channel (G-Ach) label, which is positioned after the first label to manage, for operation, administration, and maintenance (OAM).

16. The link trace method of claim 15, wherein the message is a G-ACh message, and
an LSP identifier of the link trace packet represents the first LSP and an LSP identifier of the response packet represents the second LSP.

17. The link trace method of claim 16, wherein the generating and transmitting of a link trace packet by the first router comprises generating and transmitting the link trace packet comprising an LSP label representing a transmitting segment between the first router and a next router on the first LSP and a node identifier representing the second router,
the forwarding of the received link trace packet comprises replacing an LSP label of the received link trace packet with an LSP label representing a transmitting segment between the third router and a next router on the first LSP and forwarding the packet to a next router on the first LSP, and
the performing of end processing of the received link trace packet by the second router having received the link trace packet comprises removing the first label before a G-ACh label from the link trace packet when a node identifier of the received link trace packet represents the second router, by the second router, and performing end processing of the link trace packet.

18. The link trace method of claim 17, wherein the generating and transmitting of a response packet by the third router comprises generating a response packet comprising an LSP label representing a transmitting segment between the third router and a next router after the third router on the second LSP and a node identifier representing the third router and transmitting the response packet to a next router on the second LSP, and
the generating and transmitting of a response packet by the second router comprises generating a response packet comprising an LSP label representing a transmitting segment between the second router and a next router after the second router on the second LSP and a node identifier representing the second router and transmitting the response packet to a next router on the second LSP.

19. The link trace method of claim 18, further comprising, before the finding of the fault transmitting segment by the first router, replacing, by the third router having received the response packet, an LSP label of the received response packet with an LSP label representing a transmitting segment between the third router and a next router after the third router on the second LSP and forwarding the packet to the next router after the third router on the second LSP.

20. A link trace method of a first router that is set to an MEP in an MPLS-TP network, the link trace method comprising:
generating and transmitting a link trace packet that sets a second router that is set to the MEP to a destination;
receiving a response packet to the link trace packet from the second router; and
receiving a response packet to the link trace packet from at least one third router that is set to an MIP on an LSP between the first router and the second router,
wherein the link trace packet and the response packet each comprise a first label representing a transmitting segment in which the link trace packet and the response packet are each transmitted and a message representing a link trace function, and
the message comprises packet kind information representing one of the link trace packet and the response packet, an LSP identifier representing the LSP, a tunnel identifier representing a tunnel used, and a node identifier representing a router on the LSP.
